(19) United States
(12) Patent Application Publication
(10) Pub. No.: US 2026/0233459 A1
(43) Pub. Date: Aug. 13, 2026

(54) Three-Dimensional (3D) Printing System Configured to Fabricate Sloped Layers

(71) Applicant: 3D Systems, Inc., Rock Hill, SC (US)

(72) Inventor: Akarsh Sivaprasad, Nashua, NH (US)

(21) Appl. No.: 19/533,805

(22) Filed: Feb. 9, 2026

Related U.S. Application Data
(60) Provisional application No. 63/757,094, filed on Feb. 11, 2025.
(60) Provisional application No. 63/773,770, filed on Mar. 18, 2025.

(51) Int. Cl. B29C 64/264; B29C 64/245; B29C 64/307; B33Y 10/00; B33Y 30/00

(52) U.S. Cl. CPC B29C 64/264; B29C 64/245; B29C 64/307; B33Y 10/00; B33Y 30/00

(57) ABSTRACT

A 3D printing system includes a container, a build platen, a light engine, and a controller. The container includes a transparent sheet defining a lower bound for photocurable resin. The build platen is coupled to an elevator mechanism and has an oblique lower surface defining a slope along a first lateral axis. The light engine is configured to project radiation to a build plane within the photocurable resin above the transparent sheet. The controller is programmed to harden a sloped layer of material of layer thickness t onto a lower face of the 3D article according to steps that include: (1A) Operate the light engine to scan a selectively irradiated columnar array of pixels along the first lateral axis. (1B) Concurrent with operating the light engine, operate the elevator mechanism to raise the build platen.

### CROSS-REFERENCE TO RELATED APPLICATIONS

This non-provisional patent application claims priority to U.S. Provisional Application Ser. No. 63/773,770, Entitled “A Three-Dimensional (3D) Printing System Configured to Fabricate Sloped Layers” by Akarsh Sivaprasad, filed on Mar. 18, 2025, incorporated herein by reference under the benefit of U.S.C. 119(e). This non-provisional patent application also claims priority to U.S. Provisional Application Ser. No. 63/757,094, Entitled “A Three-Dimensional (3D) Printing System Configured to Fabricate Sloped Layers” by Akarsh Sivaprasad, filed on Feb. 11, 2025, incorporated herein by reference under the benefit of U.S.C. 119(e).

### FIELD OF THE INVENTION

The present disclosure concerns an apparatus and method for fabrication of solid three dimensional (3D) articles of manufacture from radiation curable materials. More particularly, the present disclosure concerns and method and apparatus for rapidly fabricated sloped layers.

### BACKGROUND

Three dimensional (3D) printers are in rapidly increasing use for manufacturing customized articles. One class of 3D printers includes stereolithography printers having a general principle of operation including the selective curing and hardening of radiation curable (i.e., photocurable) liquid resins. One type of stereolithography system includes a containment vessel holding the curable resin, a movement mechanism coupled to a support tray, and a light engine. The stereolithography system forms a three dimensional (3D) article of manufacture by selectively curing layers of the photocurable resin onto a lower surface of the support tray. One challenge with such a system is a replenishment of resin along a lower face of the 3D article being formed and extra process time required for such replenishment.

### SUMMARY

In an aspect of the disclosure a three-dimensional (3D) printing system is configured to fabricate a three-dimensional (3D) article. The 3D printing system includes a container, a build platen, a light engine, and a controller. The container is configured to contain a photocurable resin and includes a transparent sheet defining a lower bound for the photocurable resin. The build platen is coupled to an elevator mechanism and defines an oblique lower surface configured to support the 3D article. The oblique lower surface defines a slope with respect to a first lateral axis. The light engine is configured to project radiation to a build plane within the photocurable resin above the transparent sheet. The controller is programmed to harden a sloped layer of material of layer thickness t onto a lower face of the 3D article (as it is being formed) according to steps that include: (1A) Operate the light engine to scan a selectively irradiated columnar array of pixels along the first lateral axis. The selectively irradiated columnar array of pixels is arranged along a second lateral axis that is not parallel to the first lateral axis. (1B) Concurrent with operating the light engine, operate the elevator mechanism to raise the build platen by equal to or less than the layer thickness t.

The combination of scanning (1A) and raising the oblique surface (1B) allows fresh photocurable resin to flow into a gap between the transparent sheet and the lower face of the 3D article as it is being formed. This can be accomplished with a relatively low vertical force applied between the lower face and the transparent sheet. This also eliminates a need for a separate pumping action of having to raise a horizontal lower face up and down between layers which would otherwise generate a large force on the transparent sheet and slow the process. Thus, this allows layers to be formed more rapidly without large vertical forces between the lower face and the transparent sheet.

In one implementation the selectively irradiated columnar array of pixels is scanned along a distance of length L. The elevator raises the build platen by the layer thickness t.

In another implementation—during (1A), the selectively irradiated columnar array of pixels is scanned a distance L along the first lateral axis from a starting position to an ending position as a new lower face is being defined by the hardened sloped layer. The controller is further programmed to harden an additional layer of material onto the new lower face according to the following steps: (2A) Operate the light engine to scan the selectively irradiated columnar array of pixels along the first lateral axis from the starting position to the ending position. (2B) concurrent with operating the light engine, operate the elevator mechanism to raise the build platen. (3) repeat concurrent steps (2A) and (2B) until the 3D article is fully fabricated.

In another implementation the selectively irradiated columnar array of pixels includes a plurality of columnar arrays of pixels separated from each other along the first lateral axis and individually arranged along the second lateral axis.

In yet another implementation the columnar array of pixels has a single pixel width along the first lateral axis.

In a further implementation the columnar array of pixels has a width along the first lateral axis of a plurality of pixels.

### BRIEF DESCRIPTION OF THE FIGURES

FIG. 1 is an isometric drawing of a three-dimensional (3D) printing system 2. FIG. 1 also illustrates—in floating isolation—a container for photocurable resin and a three-dimensional (3D) article.

FIG. 2 is a simplified electrical block diagram of a three-dimensional (3D) printing system.

FIG. 3 is a flowchart depicting formation of a single layer of material which is repeated to form a three-dimensional (3D) article.

FIG. 4A is a side cutaway view of a portion of a 3D printing system with a columnar beam impinging upon a starting location of a scan in an X-direction.

FIG. 5A is detail taken from FIG. 4A.

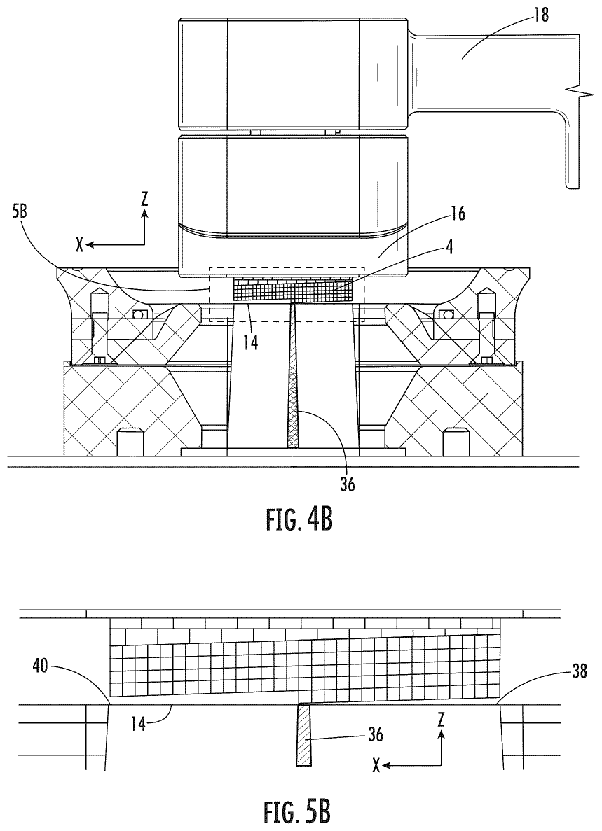

FIG. 4B is a side cutaway view of a portion of a 3D printing system with a columnar beam impinging upon a location at a midpoint of a scan in an X-direction.

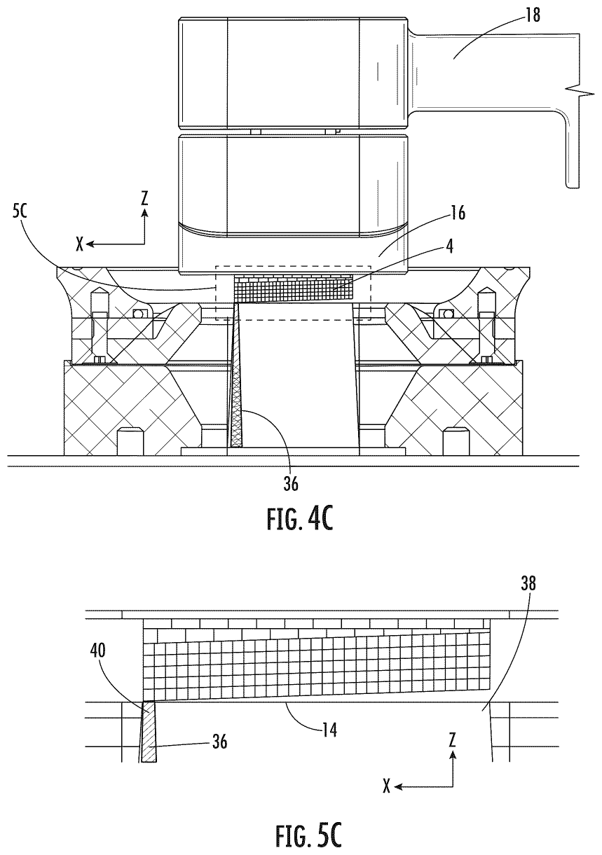

FIG. 5B is detail taken from FIG. 4B.

FIG. 4C is a side cutaway view of a portion of a 3D printing system with a columnar beam impinging upon an ending location of a scan in an X-direction.

FIG. 5C is detail taken from FIG. 4C.

### DETAILED DESCRIPTION OF THE PREFERRED EMBODIMENTS

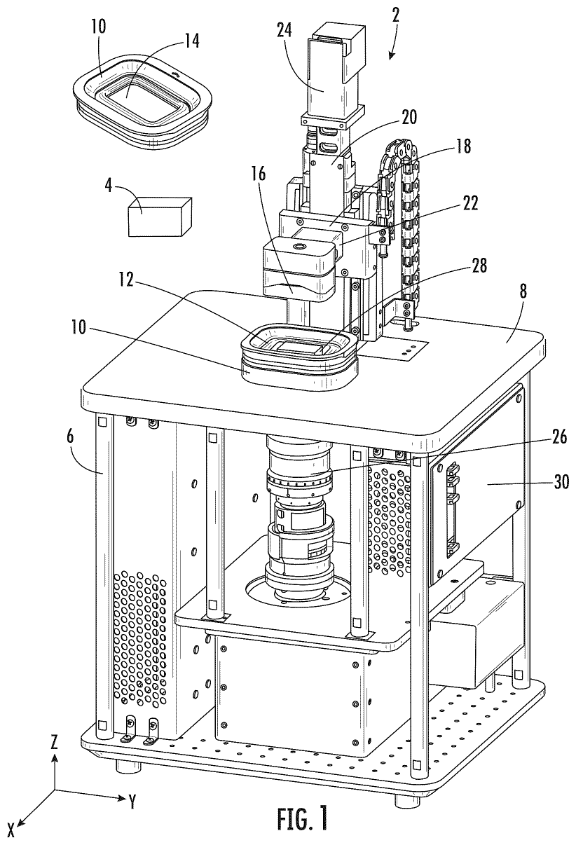

FIG. 1 is an isometric drawing depicting an embodiment of three-dimensional (3D) printing system 2 configured to fabricate a 3D article 4 (shown “floating” in isolation). In describing 3D system 2, mutually perpendicular axes X, Y, and Z will be used. Axes X and Y (X-axis and Y-axis) are generally horizontal lateral axes. Axis Z (Z-axis) is a vertical axis that is generally aligned with a gravitational reference. In using the word “generally” it is implied that a limitation that is “generally” true is by design but to within manufacturing tolerances. Additionally angular axes theta-X, theta-Y, and theta-Z are rotations about the X, Y, and Z axes respectively.

The 3D printing system 2 includes a chassis 6 supporting various components. A base 8 supports a container 10 (shown installed on base 8 and “floating” in isolation) configured to contain a photocurable resin 12. The container 10 includes, on a lower side, a transparent sheet 14 that provides a lower bound for the contained photocurable resin 12. The transparent sheet 14 is “transparent” in the sense that it is transparent to radiation with a wavelength that is within a range from blue to violet to ultraviolet or from 100 to 500 nanometers (nm). Such a transparent sheet 14 can be formed from materials such as Polydimethylsiloxane (PDMS), Polytetrafluoroethylene (PTFE), amorphous fluoropolymers, and other such materials known in the art of stereolithography.

The photocurable resin 12 is a polymer-based fluid that includes, inter alia, a monomer and a catalyst. The catalyst is sensitive to radiation within the blue to ultraviolet range to cause the monomer to crosslink and/or polymerize into a solid. Photocurable resins are well known in the art for stereolithography and rapid prototyping.

Chassis 6 supports a build platen 16 above the container 10 by an elevator mechanism 18. The elevator mechanism 18 is configured to vertically position the build platen 16 with respect to the Z-axis. The elevator mechanism 18 includes a vertical movement mechanism 20 coupled to an elevator 22.

An embodiment of vertical movement mechanism 20 includes a motorized ball bearing screw mechanism or otherwise referred to as a ball screw mechanism. A ball screw mechanism includes a vertical screw shaft that passes through a ball nut. The ball nut contains recirculating steel balls and translates vertically. The vertical screw shaft has helical channels that engage the recirculating balls. The elevator 22 includes the ball nut. A motor 24 is coupled to the vertical screw shaft and is configured to selectively rotate the vertical screw shaft. As the vertical screw shaft rotates, the action of the vertical screw shaft upon the ball nut translates the elevator upward and downward depending on a direction of rotation. Such a vertical movement mechanism 20 is known in the art for precision positioning along vertical, horizontal, and oblique axes.

Another embodiment of a vertical movement mechanism 20 is a motorized lead screw mechanism. With such an embodiment, the motor 24 would turn a lead screw that drives a nut carried by the elevator 18. Yet another embodiment of a vertical movement mechanism 20 is a rack and pinion mechanism. A further embodiment is a motorized belt/pulley system. All such vertical movement mechanisms are known in the art for two and three dimensional printing systems for transport along X, Y, Z, and oblique axes.

The chassis 6 supports a light engine 26 below the container 10. The light engine 26 is configured to project pixelated radiation to a build plane 28 that is within the photocurable resin 12 just above the transparent sheet 14. In an illustrative embodiment, the build plane 28 defines a horizontal rectangular area that is less than 1 millimeter above the transparent sheet 14.

In the illustrated embodiment, the light engine 26 is a projection light engine 26 that includes a “digital light processor” or “digital mirror device” type of light engine 26. The light engine 26 includes a light source, a micromirror array, projection optics, a light trap, and other optics for reflecting, diverging, and/or converging bundles of radiation. The light source can be a mercury arc lamp or an array of light emitting diodes. The micromirror array includes a rectangular M×N array of at least one million tiny electronically deflectable mirrors. In an OFF state, an individual mirror receives radiation from the light source and deflects the radiation into the light trap which absorbs the radiation. In an ON state, an individual mirror receives radiation from the light source and deflects the radiation into the projection optics which in turn focuses the radiation onto a pixel on the build plane.

The build plane 28 is therefore selectively irradiated by an M×N array of pixels that correspond to the M×N array of deflectable mirrors. Thus, the light engine 26 can selectively irradiate the M×N array of pixels in the build plane 28. The M×N array includes M columns and N rows. A single column linearly extends along the X-axis. The columns are therefore arranged along the Y-axis. A “columnar” array of pixels can be a single column or a contiguous group of columns. For example, a four pixel columnar array can be four pixels wide in the N rows along the X-axis.

The chassis 6 supports and/or is coupled to a controller 30. Controller 30 is electrically and/or wirelessly coupled to the elevator mechanism 18 (and thus to the motor 24), the light engine 26, and other system components such as actuators and sensors. The controller 30 minimally includes an information storage device coupled to a processor. The information storage device is a non-volatile or non-transient storage device storing software instructions. When the software instructions are executed by the processor, the processor thereby controls components of the system 2 including the elevator mechanism 18 and the light engine 26. As a note, the controller 30 can be a single unit contained within chassis 6 or it can includes additional controllers 30 that are outside of or even remote relative to the chassis 6. As such, controller 30 can refer to one or more of an internal microcontroller, a laptop computer, a desktop computer, a smartphone, a local server, a remote server, and a mainframe computer to name some examples.

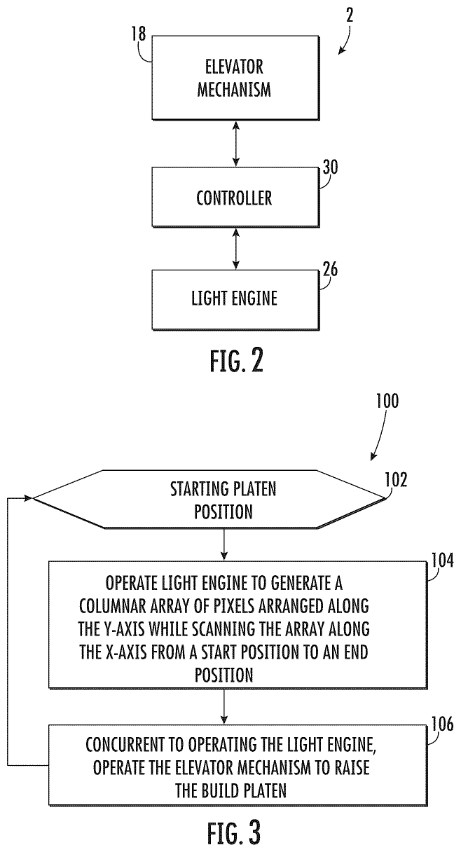

FIG. 2 is a simplified electrical block diagram illustrating controller 30 coupled to the elevator mechanism 18 and light engine 26. It is to be understood that controller 30 is also coupled to other devices such as mechanical actuators (motorized cams, solenoid/magnet movers, etc.) and sensors.

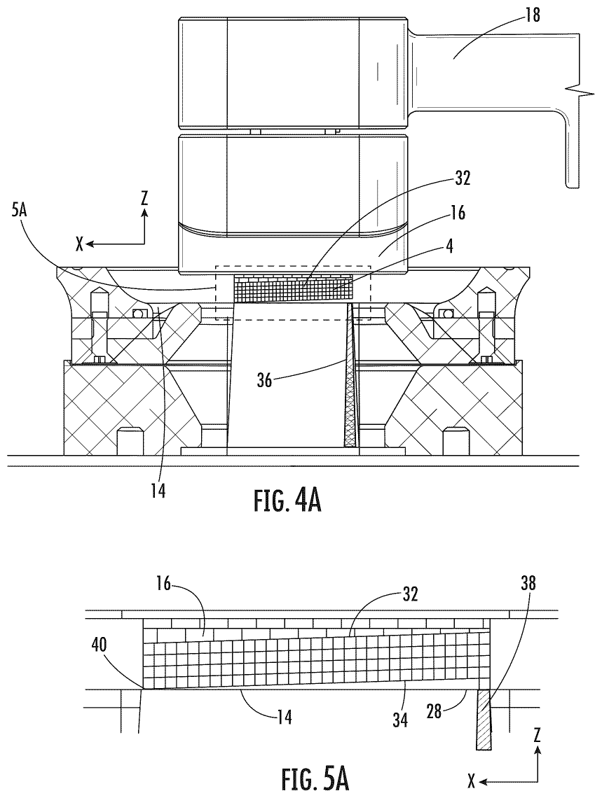

System 2 is configured to fabricate the article 4 in a layer by layer manner. Unlike conventional stereolithography systems, system 2 forms layers that are slightly oblique relative to a horizontal axis or plane. FIGS. 3, 4A-C, and 5A-C are intended to describe and illustrate fabrication of a single oblique layer. FIG. 3 is a flowchart used to describe formation of a single layer. FIGS. 4A-C and 5A-C illustrate a scan sequence for forming a layer. FIGS. 5A-C are included to illustrate detail of FIGS. 4A-C respectively.

Referring to FIGS. 4A and 5A, the build platen 16 has an oblique lower surface 32 upon which layers of the 3D article 4 are formed with a like angle. The lower surface 32 has a negative slope along the X-axis. The lower surface 32 has a zero slope with respect to the Y-axis. In FIG. 5A a lower face 34 of the article 4 under formation is a lower surface of a most recently formed layer.

In the illustrated embodiment, the oblique lower surface 32 is a metal or otherwise permanent lower surface or face of the build platen 16. In an alternative embodiment, the lower surface 32 of the build platen can be formed by three-dimensionally printing and hardening layers of the photocurable resin 12 upon a metal or permanent portion of the build platen 16.

In the illustrated embodiment, the oblique lower surface 32 is shown sloping along the X-axis. However, in other embodiments, the oblique lower surface 32 can slope along the Y-axis or a lateral axis that is oblique relative to the X-axis and Y-axis. Therefore, a “first lateral axis” can be defined as an axis along which the oblique lower surface 32 is sloped which can be along the X-axis, Y-axis, or a lateral axis that is oblique with respect to the X and Y axes.

Also illustrated in FIGS. 4A and 5A is a columnar beam of radiation 36 projected from the light engine 26 that is illuminating a column of the build plane 28 at a “starting position” 38. Starting position 38 and ending position 40 are defined along the X-axis. The columnar beam of radiation 36 is illustrated as selectively irradiating and hardening area of the photocurable resin 12 that is a single pixel wide along the X-axis but over the entire Y-axis. In other embodiments, the columnar beam of radiation 36 can be two, three, four, or more pixels wide along the X-axis in other embodiments but will always be a fraction (typically or perhaps less than 5%) of the build plane along the X-axis.

Referring to the method 100 of FIG. 3, a process of forming a single layer starts with the build platen in the vertical position of FIGS. 4A and 5A. According to 102, the build platen 16 is positioned with a lower face 34 (initially the platen 16 itself but later of the 3D article) vertically positioned one layer thickness above the build plane 28 or an upper surface of the transparent sheet 14 at the starting position 38. Then, step 104 begins.

According to 104, the light engine 26 is operated to generate a selectively illuminated columnar array of pixels 36 arranged along the Y-axis. Also according to 104, the light engine 26 scans the columnar array of pixels along the X-axis. The change in position of the columnar beam of radiation 36 during step 104 is illustrated in the sequential set of FIG. 4A/5A, then 4B/5B, and finally 4C/5C. During step 104, the columnar light beam 36 traverses a distance L, from the starting position 38 to an ending position 40 defined along the X-axis. As the columnar light beam 36 is scanned, individual pixels of the build plane irradiated by the columnar light beam 36 are turned on and off according to a design of a layer of article 4.

Concurrent with step 104, step 106 is performed. As used herein, “concurrent” may be either (i) simultaneous motion of the build platen 16 and irradiation of the light beam 36, such that the build platen moves continuously, or (ii) intermittent motion of the elevator mechanism to raise the build platen in steps while the light beams are irradiated between steps. During step 106, the elevator mechanism 18 is operated to raise the build platen 16 by one layer thickness t. Then, the sequence of steps 102-106 can be repeated until all layers of the 3D article 4 have been formed.

In one embodiment, the oblique lower surface 32 is defined by a permanent portion of the build platen 16. Alternatively, the build platen 16 begins with a horizontal lower surface. As part of or prior to step 102 method 100 can include a formation of the oblique lower surface 32 in a layer-by-layer manner onto the horizontal lower surface. This will include the controller 30 operating the elevator mechanism 18 and the light engine 26 to form layers that provide the oblique lower surface 32.

In the illustrated embodiment, beam 36 is shown as a single columnar light beam 36. In an alternative embodiment, beam 36 can includes a plurality of columnar light beams that are spaced along the X-axis. Then, the scan distance L will be a fraction of the build plane dimension along the X-axis. For example, if three columnar light beams 36 are used simultaneously, the scan distance L will be one third of the total scan distance along the X-axis, and the build process will take approximately one third of the time. For such as configuration, the lower surface 32 of the build platen will have a “sawtooth” geometry. This alternative embodiment would enable a faster formation of a new layer due to the shorter scan distance.

The specific embodiments and applications thereof described above are for illustrative purposes only and do not preclude modifications and variations encompassed by the scope of the following claims.

What is claimed:

1. A three-dimensional (3D) printing system configured to fabricate a three-dimensional (3D) article comprising:
a container configured to contain a photocurable resin, the container including a transparent sheet defining a lower bound for the photocurable resin;
a build platen coupled to an elevator mechanism, the build platen has an oblique lower surface configured to support the 3D article, the oblique lower surface defining a slope along a first lateral axis;
a light engine configured to project radiation to a build plane within the photocurable resin above the transparent sheet; and
a controller programmed to harden a sloped layer of material of layer thickness t onto a lower face of the 3D article according to the following steps:
(1A) operate the light engine to scan a selectively irradiated columnar array of pixels along the first lateral axis, the selectively irradiated columnar array of pixels arranged along a second lateral axis that is not parallel to the first lateral axis;
(1B) concurrent with operating the light engine, operate the elevator mechanism to raise the build platen.

2. The three-dimensional (3D) printing system of claim 1 wherein the selectively irradiated columnar array of pixels is scanned along a distance of length L, the elevator raises the build platen by the layer thickness t.

3. The three-dimensional (3D) printing system of claim 1 wherein during (1A), the selectively irradiated columnar array of pixels is scanned a distance L along the first lateral axis from a starting position to an ending position as a new lower face is being defined by the hardened sloped layer, the controller is further programmed to harden an additional layer of material onto the new lower face according to the following steps:
(2A) operate the light engine to scan the selectively irradiated columnar array of pixels along the first lateral axis from the starting position to the ending position;
(2B) concurrent with operating the light engine, operate the elevator mechanism to raise the build platen;
(3) repeat concurrent steps (2A) and (2B) until the 3D article is fully fabricated.

4. The three-dimensional (3D) printing system of claim 1 wherein the first lateral axis is perpendicular to the second lateral axis.

5. The three-dimensional (3D) printing system of claim 1 wherein prior to step (1A) the controller is configured to operate the elevator mechanism and the light engine to form the oblique lower surface in a layer-by-layer manner.

6. The three-dimensional (3D) printing system of claim 1 wherein the selectively irradiated columnar array of pixels includes a plurality of columnar arrays of pixels separated from each other along the first lateral axis and individually arranged along the second lateral axis.

7. The three-dimensional (3D) printing system of claim 1 wherein the columnar array of pixels has a single pixel width along the first lateral axis.

8. The three-dimensional (3D) printing system of claim 1 wherein the columnar array of pixels has a width along the first lateral axis of a plurality of pixels.

9. The three-dimensional (3D) printing system of claim 1 wherein the columnar array of pixels spans at least 80 percent of the build plane along the second lateral axis.

10. A method of manufacturing a three-dimensional (3D) article comprising the steps of:
configuring a three-dimensional (3D) printing system to manufacture the three-dimensional (3D) article with hardware including:
a container configured to contain a photocurable resin, the container including a transparent sheet defining a lower bound for the photocurable resin;
a build platen coupled to an elevator mechanism, the build platen has an oblique lower surface configured to support the 3D article, the oblique lower surface defining a slope along a first lateral axis;
a light engine configured to project radiation to a build plane within the photocurable resin above the transparent sheet; and
a controller programmed to harden a sloped layer of material of layer thickness t onto a lower face of the 3D article;
(1A) operating the light engine to scan a selectively irradiated columnar array of pixels along the first lateral axis, the selectively irradiated columnar array of pixels arranged along a second lateral axis which is not parallel to the first lateral axis; and
(1B) concurrent with operating the light engine, operating the elevator mechanism to raise the build platen.

11. The method of claim 10 wherein the selectively irradiated columnar array of pixels is scanned along a distance of length L, elevator raises the build platen by the layer thickness t.

12. The method of claim 10 wherein during (1A), the selectively irradiated columnar array of pixels is scanned a distance L along the first lateral axis from a starting position to an ending position as a new lower face is being defined by the hardened sloped layer, the controller is further programmed to harden an additional layer of material onto the new lower face according to the following steps:
(2A) operate the light engine to scan the selectively irradiated columnar array of pixels along the first lateral axis from the starting position to the ending position;
(2B) concurrent with operating the light engine, operate the elevator mechanism to raise the build platen;
(3) repeat concurrent steps (2A) and (2B) until the 3D article is fully fabricated.

13. The method of claim 10 wherein the first lateral axis is perpendicular to the second lateral axis.

14. The method of claim 10 wherein prior to step (1A) the method includes operating the elevator mechanism and the light engine to form the oblique lower surface in a layer-by-layer manner.

15. The method of claim 10 wherein the selectively irradiated columnar array of pixels includes a plurality of columnar arrays of pixels separated from each other along the first lateral axis and individually arranged along the second lateral axis.

16. The method of claim 10 wherein the columnar array of pixels has a width along the first lateral axis of a plurality of pixels.

17. A non-transient information storage device storing software instructions, upon execution by a processor the software instructions programmed to operate a three-dimensional (3D) printing system and to fabricate a three-dimensional (3D) article from a series of sloped layers including, for individual layers the following steps:
(1A) operate the light engine to scan a selectively irradiated columnar array of pixels along a first lateral axis, the selectively irradiated columnar array of pixels arranged along a second lateral axis which is not parallel to the first lateral axis;
(1B) concurrent with operating the light engine, operate the elevator mechanism to raise the build platen.

18. The non-transient information storage device of claim 17 wherein during (1A), the selectively irradiated columnar array of pixels is scanned a distance L along the first lateral axis from a starting position to an ending position as a new lower face is being defined by the hardened sloped layer, the controller is further programmed to harden an additional layer of material onto the new lower face according to the following steps:
(2A) operate the light engine to scan the selectively irradiated columnar array of pixels along the first lateral axis from the starting position to the ending position;
(2B) concurrent with operating the light engine, operate the elevator mechanism to raise the build platen;
(3) repeat concurrent steps (2A) and (2B) until the 3D article is fully fabricated.

19. The non-transient information storage device of claim 17 wherein prior to step (1A) the software instructions are programmed to operate the elevator mechanism and the light engine to form the oblique lower surface in a layer-by-layer manner.

20. The method of claim 17 wherein the first lateral axis is perpendicular to the second lateral axis.
